(19) United States
(12) Patent Application Publication
(10) Pub. No.: US 2016/0215957 A1
(43) Pub. Date: Jul. 28, 2016

(54) SIGNAL LIGHT

(71) Applicant: LITE-ON TECHNOLOGY CORPORATION, Taipei City (TW)

(72) Inventors: KUO-HUI CHANG, Taipei City (TW); YI-KAI CHENG, Taipei City (TW); SHIH-CHANG WANG, Taipei City (TW)

(21) Appl. No.: 14/807,314

(22) Filed: Jul. 23, 2015

(30) Foreign Application Priority Data
Jan. 28, 2015 (TW) 104102828

(51) Int. Cl. F21V 5/04; F21S 8/08

(52) U.S. Cl. CPC F21V 5/045; F21S 8/086; F21Y 2101/02

(57) ABSTRACT

A signal light includes a case, a light emitting unit, a light distribution cover, and a curved lens. The case includes a bottom case. The light emitting unit is located on the bottom case. The light distribution cover is connected to the case. The light distribution cover includes an inclined curved surface. The curved lens is located between the bottom case and the inclined curved surface.

### BACKGROUND OF THE INVENTION

1. Field of the Invention

The present invention relates to a signal light; more particularly, the present invention relates to a signal light for preventing the sun phantom phenomenon to increase traffic safety.

2. Description of the Related Art

To ensure the safety of the pedestrians or cars on the road, a traffic light is placed on the road to notify the pedestrians or cars whether to stop or to go. The common traffic light has a light source, a Fresnel lens, and a light distribution front cover. The light source is used for emitting a light. The Fresnel lens is used for focusing the light to emit to the outside. The light distribution front cover is a translucent sheet of various colors (such as red, yellow, or green), for allowing the light which is focused by the Fresnel lens to have a specific color, and for allowing the light to be emitted to the outside, such that the user can see the lights of different colors to understand the current traffic situation.

However, at daybreak or at sunset, sunlight is emitted horizontally to the traffic light; in this situation, the Fresnel lens and the inner surface and the outer surface of the light distribution front cover will reflect a portion of the sunlight; the sunlight reflected by the Fresnel lens and the light distribution front cover is concentrated well, such that the illumination brightness of the reflected light is great; as a result, the traffic light will produce a phenomenon of luminescence called the sun phantom phenomenon. The sun phantom phenomenon will cause the pedestrian or driver to misperceive an un-illuminated traffic light as illuminated and misjudge the walking or driving time, thereby increasing the probability of a traffic accident.

Therefore, there is a need to provide a new traffic light to prevent the sun phantom phenomenon and increase traffic safety.

### SUMMARY OF THE INVENTION

It is an object of the present invention to provide a signal light used for preventing the sun phantom phenomenon to increase traffic safety.

To achieve the abovementioned object, the signal light of the present invention includes a case, a light emitting unit, a light distribution cover and a curved lens. The case includes a bottom case. The light emitting unit is located on the bottom case. The light distribution cover is connected to the case. The light distribution cover includes an inclined curved surface. The curved lens is located between the bottom case and the inclined curved surface.

According to one embodiment of the present invention, the inclined curved surface includes an inclined curved surface center. At a position of the inclined curved surface center, the inclined curved surface includes a tangent line. A first inclination angle is formed between the tangent line of the inclined curved surface and a horizontal line.

According to one embodiment of the present invention, a range of the first inclination angle is 80 to 87 degrees.

According to one embodiment of the present invention, the curved lens includes a curved lens center. At a position of the curved lens center, the curved lens includes a tangent line, and the tangent line of the curved lens is substantially perpendicular to the horizontal line.

According to one embodiment of the present invention, the curved lens includes a curved lens center. At a position of the curved lens center, the curved lens includes a tangent line, and a second inclination angle is formed between the tangent line of the curved lens and the horizontal line.

According to one embodiment of the present invention, a range of the second inclination angle is 80 to 87 degrees.

According to one embodiment of the present invention, the curved lens includes an axis part and a concentrator structure array, and the concentrator structure array is around the axis part.

According to one embodiment of the present invention, the concentrator structure array takes the axis part as a center and represents an axial symmetric shape, and the axis part is located at the curved lens center.

According to one embodiment of the present invention, the axis part is not located at the curved lens center.

According to one embodiment of the present invention, the axis part is located on a surface of the curved lens toward the inclined curved surface, or located on a surface of the curved lens toward the bottom case, or both are located on the surface of the curved lens toward the inclined curved surface and on the surface of the curved lens toward the bottom case.

According to one embodiment of the present invention, the concentrator structure array is located on the surface of the curved lens toward the inclined curved surface, or the surface of the curved lens toward the bottom case, or both are located on the surface of the curved lens toward the inclined curved surface and on the surface of the curved lens toward the bottom case.

### BRIEF DESCRIPTION OF THE DRAWINGS

FIG. 1 illustrates a schematic drawing of the signal light of the first embodiment of the present invention.

FIG. 2 illustrates a sectional view of the signal light of the first embodiment of the present invention.

FIG. 3 illustrates a schematic drawing of the signal light and the sun of the first embodiment of the present invention.

FIG. 4 illustrates a schematic drawing of the curved lens of the signal light of the first embodiment of the present invention.

FIG. 5 illustrates a sectional view of the signal light of the second embodiment of the present invention.

FIG. 6 illustrates a sectional view of the signal light of the third embodiment of the present invention.

FIG. 7 illustrates a schematic drawing of the curved lens of the signal light of the third embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

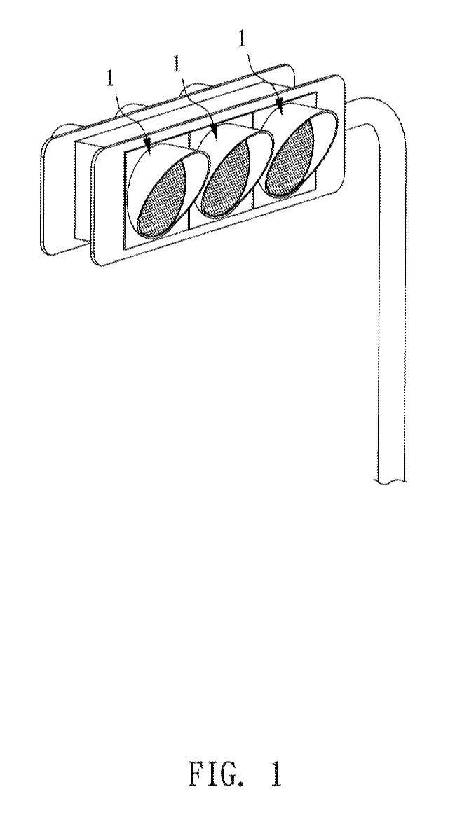

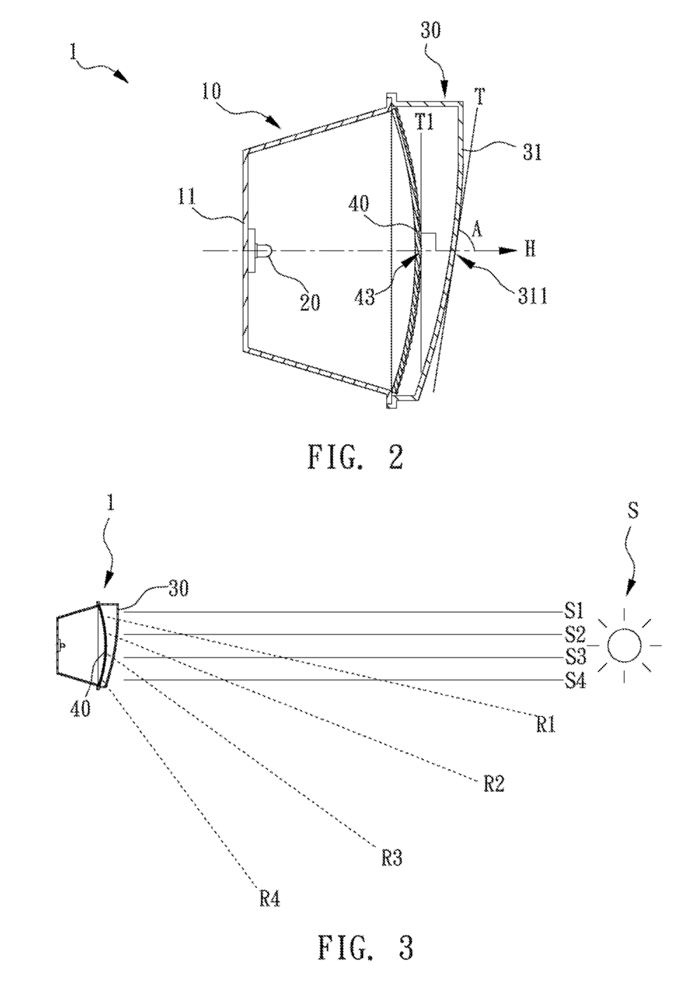

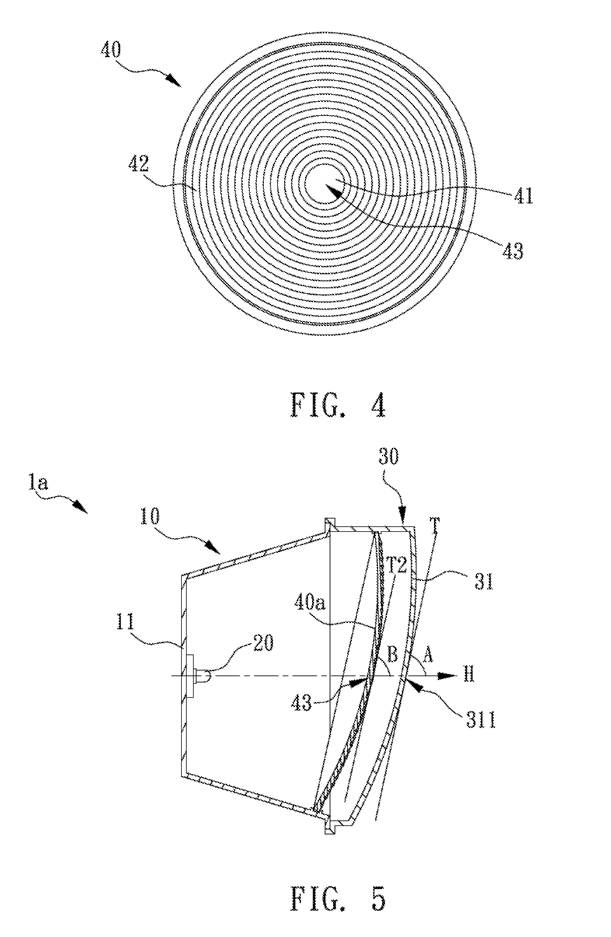

Please refer to FIG. 1 to FIG. 4 about the signal light of the first embodiment of the present invention. FIG. 1 illustrates a schematic drawing of the signal light of the first embodiment of the present invention. FIG. 2 illustrates a sectional view of the signal light of the first embodiment of the present invention. FIG. 3 illustrates a schematic drawing of the signal light and the sun of the first embodiment of the present invention. FIG. 4 illustrates a schematic drawing of the curved lens of the signal light of the first embodiment of the present invention.

As shown in FIG. 1 and FIG. 2, in the first embodiment of the present invention, the signal light 1 is a traffic light. The signal light 1 includes a case 10, a light emitting unit 20, a light distribution cover 30 and a curved lens 40. However, the type of the signal light 1 is not limited to the traffic light; the signal light 1 can also be another type of light, such as a level crossing light.

In the first embodiment of the present invention, the case 10 is used for covering and protecting the electronic elements in the signal light 1. The case 10 includes a bottom case 11. The light emitting unit 20 is a light-emitting diode (LED) light for emitting a light, and the light emitting unit 20 is located on the bottom case 11. However, the type of the light emitting unit 20 is not limited to the light-emitting diode, and it can be changed to another kind of light-emitting unit according to requirements.

As shown in FIG. 2, in the first embodiment of the present invention, the light distribution cover 30 is a translucent sheet of different colors (such as red, yellow, or green). The light distribution cover 30 is used for allowing the light emitted by the light emitting unit 20 to pass through, such that the light can have a specific color, and the light can be emitted to the outside at an oblique angle. The light distribution cover 30 is connected to the case 10. The light distribution cover 30 includes an inclined curved surface 31. The inclined curved surface 31 is a curved structure which tilts slightly downward. The inclined curved surface 31 includes an inclined curved surface center 311. At the position of the inclined curved surface center 311, the curved structure of the inclined curved surface 31 has a tangent line T. A first inclination angle A is formed between the tangent line T of the inclined curved surface 31 and a horizontal line H, and the range of the first inclination angle A is 80 to 87 degrees. However, the range of the first inclination angle A of the first embodiment of the present invention is not limited to that design; the range can be changed according to variable design requirements.

As shown in FIG. 2 and FIG. 4, in the first embodiment of the present invention, the curved lens 40 is a Fresnel lens, and the shape of the curved lens 40 is a curved circular lens which projects outwardly. The curved lens 40 is located between the bottom case 11 and the inclined curved surface 31 for allowing the light to focus to form a parallel light. The curved lens 40 includes an axis part 41, a concentrator structure array 42 and a curved lens center 43. At the position of the curved lens center 43, the curved lens 40 has a tangent line T1, and the tangent line T1 of the curved lens 40 is substantially perpendicular to the horizontal line H. The axis part 41 is located at the curved lens center 43 of the curved lens 40. The concentrator structure array 42 is around the axis part 41. The concentrator structure array 42 is a plurality of saw-tooth ring structures, and the concentrator structure array 42 takes the axis part 41 as a center and represents an axial symmetric shape. The concentrator structure array 42 is located on an outer surface (the surface toward the inclined curved surface 31) of the curved lens 40, and the inner surface of the curved lens 40 is a smooth arcuate surface. The saw-tooth ring structures of the concentrator structure array 42 of the outwardly projecting curved lens 40 are used for allowing the light to focus to form parallel light to be emitted to the inclined curved surface 31, and to be emitted to the outside via the inclined curved surface 31. In addition, if the combination of the inclined curved surface 31 and the curved lens 40 is irradiated by an external light, the combination can reflect the external light to the outside at an oblique angle. However, the axis part 41 and the concentrator structure array 42 are not limited to being located on the outer surface of the curved lens 40; they can also be located on the inner surface (the surface toward the bottom case 11) of the curved lens 40; alternatively, the axis part 41 and the concentrator structure array 42 can be located on both the inner surface and the outer surface of the curved lens 40; or the axis part 41 can be located on the inner surface of the curved lens 40, and the concentrator structure array 42 can be located on the outer surface of the curved lens 40 or on both the inner surface and the outer surface of the curved lens 40; or the concentrator structure array 42 can be located on the outer surface of the curved lens 40, and the concentrator structure array 42 can be located on the inner surface of the curved lens 40 or on both the inner surface and the outer surface of the curved lens 40; or the axis part 41 can be located on both the inner surface and the outer surface of the curved lens 40, and the concentrator structure array 42 can be located on the inner surface or the outer surface of the curved lens 40; the arrangement of the axis part 41 and the concentrator structure array 42 for the inner surface and the outer surface of the curved lens 40 can be changed according to various requirements. In addition, the structures of the axis part 41 and the concentrator structure array 42 of the curved lens 40 of the Fresnel lens are disclosed in the field of the lens, so there is no need for further description.

As shown in FIG. 2 to FIG. 4, at daybreak or sunset, the irradiation height of the sun S is low, such that the sunlight S1, S2, S3, S4 will be emitted to the signal light 1 at a horizontal angle. When the sunlight S1, S2, S3, S4 is emitted to the light distribution cover 30, a portion of the sunlight S1, S2, S3, S4 will be reflected to the outside at an inclined and expanding angle by the inclined curved surface 31 of the light distribution cover 30, and the other portion of the sunlight S1, S2, S3, S4 will pass through the inclined curved surface 31 to shine on the curved lens 40. When the other portion of the sunlight S1, S2, S3, S4 passes through the inclined curved surface 31 to shine onto the curved lens 40, the surface of the curved lens 40 with the concentrator structure array 42 and the inner surface of the curved lens 40 without the concentrator structure array 42 will reflect the other portion of the sunlight S1, S2, S3, S4 to the inclined curved surface 31 at different inclined angles; then the inclined curved surface 31 will cause the other portion of the sunlight S1, S2, S3, S4 be emitted to the outside in a further inclined and expanding angle. Therefore, via the reflection of the inclined curved surface 31, the reflection of the inner surface and the outer surface of the curved lens 40 and the divergent light distribution of the inclined curved surface 31 can transform the horizontal sunlight S1, S2, S3, S4 into expanding reflected light R1, R2, R3, R4. Because the irradiation range of the reflected light R1, R2, R3, R4 is wide, the light will not concentrate in a local direction, allowing the illumination brightness of the reflected light R1, R2, R3, R4 to be low; therefore, the signal light 1 of the present invention can prevent the sun phantom phenomenon to increase traffic safety.

Please refer to FIG. 5 about the signal light of the second embodiment of the present invention. FIG. 5 illustrates a sectional view of the signal light of the second embodiment of the present invention.

As shown in FIG. 5, the difference between the second embodiment and the first embodiment of the present invention is that, in the second embodiment, at the position of the curved lens center 43, the curved lens 40a has a tangent line T2. The tangent line T2 and the horizontal line H are not perpendicular to each other. A second inclination angle B is formed between the tangent line T2 of the curved lens 40a of the second embodiment and the horizontal line H, and the range of the second inclination angle B is 80 to 87 degrees. The curved lens 40a of the second embodiment tilts slightly downward; therefore, the combination of the curved lens 40a and the inclined curved surface 31 of the light distribution cover 30 can cause the reflected light of the sun to be emitted to the outside at a further inclined and expanding angle.

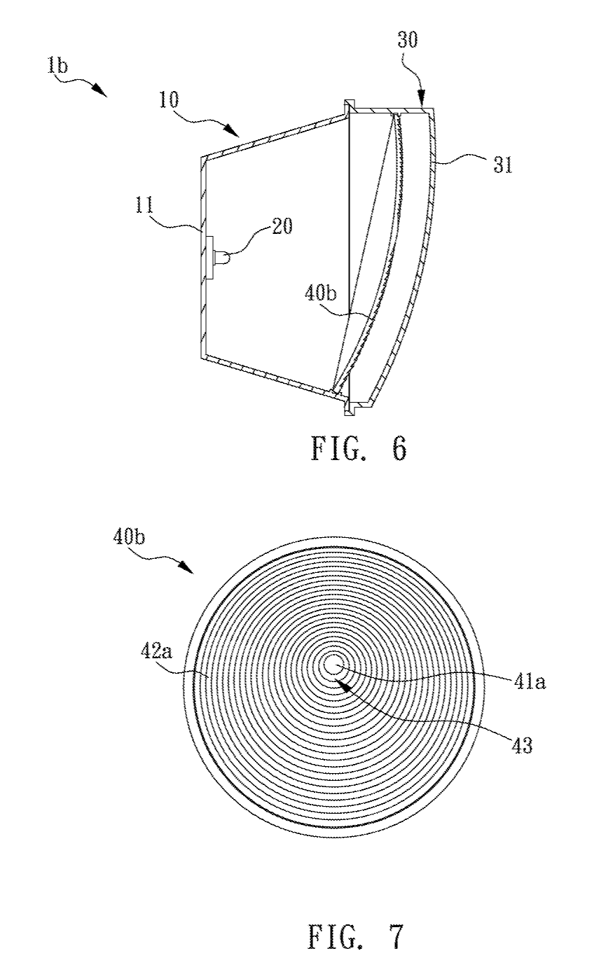

Please refer to FIG. 6 and FIG. 7 about the signal light of the third embodiment of the present invention. FIG. 6 illustrates a sectional view of the signal light of the third embodiment of the present invention. FIG. 7 illustrates a schematic drawing of the curved lens of the signal light of the third embodiment of the present invention.

As shown in FIG. 6 and FIG. 7, the difference between the third embodiment and the second embodiment is that, in the signal light 1b of the third embodiment of the present invention, the axis part 41a is not located at the curved lens center 43 of the curved lens 40b. The concentrator structure array 42a is around the axis part 41a, but the axis part 41a is not located at the curved lens center 43 of the curved lens 40b, and the axis part 41a is located at an upper position of the curved lens 40b; therefore, the concentrator structure array 42a does not take the axis part 41a as a center to represent an axial symmetric shape. Via the design of the curved lens 40b of the third embodiment, the combination of the curved lens 40b and the inclined curved surface 31 of the light distribution cover 30 can cause the reflected light of the sun to be emitted to the outside at a further inclined and expanding angle.

Via the design of the signal lights 1, 1a, 1b of the present invention, the original horizontal sunlight S1, S2, S3, S4 will be transformed into the expanding reflected light R1, R2, R3, R4. Because the illumination range of the reflected light R1, R2, R3, R4 is wide, the light will not be concentrated in a local direction, such that the illumination brightness of the reflected light R1, R2, R3, R4 will be low; therefore, the signal lights 1, 1a, 1b of the present invention can prevent the sun phantom phenomenon to increase traffic safety.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the spirit and scope of the invention.

What is claimed is:

1. A signal light, comprising:
a case, comprising a bottom case;
a light emitting unit, located on the bottom case;
a light distribution cover, connected to the case, wherein the light distribution cover comprises an inclined curved surface; and
a curved lens, located between the bottom case and the inclined curved surface.

2. The signal light as claimed in claim 1, wherein the inclined curved surface comprises an inclined curved surface center; at a position of the inclined curved surface center, the inclined curved surface comprises a tangent line, and a first inclination angle is formed between the tangent line of the inclined curved surface and a horizontal line.

3. The signal light as claimed in claim 2, wherein a range of the first inclination angle is 80 to 87 degrees.

4. The signal light as claimed in claim 3, wherein the curved lens comprises a curved lens center; at a position of the curved lens center, the curved lens comprises a tangent line, and the tangent line of the curved lens is substantially perpendicular to the horizontal line.

5. The signal light as claimed in claim 3, wherein the curved lens comprises a curved lens center; at a position of the curved lens center, the curved lens comprises a tangent line, and a second inclination angle is formed between the tangent line of the curved lens and the horizontal line.

6. The signal light as claimed in claim 5, wherein a range of the second inclination angle is 80 to 87 degrees.

7. The signal light as claimed in claim 4, wherein the curved lens comprises an axis part and a concentrator structure array, and the concentrator structure array is around the axis part.

8. The signal light as claimed in claim 6, wherein the curved lens comprises an axis part and a concentrator structure array, and the concentrator structure array is around the axis part.

9. The signal light as claimed in claim 7, wherein the concentrator structure array takes the axis part as a center and represents an axial symmetric shape, and the axis part is located at the curved lens center.

10. The signal light as claimed in claim 7, wherein the axis part is not located at the curved lens center.

11. The signal light as claimed in claim 7, wherein the axis part is located on a surface of the curved lens toward the inclined curved surface, or located on a surface of the curved lens toward the bottom case, or both are located on the surface of the curved lens toward the inclined curved surface and on the surface of the curved lens toward the bottom case.

12. The signal light as claimed in claim 11, wherein the concentrator structure array is located on the surface of the curved lens toward the inclined curved surface, or the surface of the curved lens toward the bottom case, or both are located on the surface of the curved lens toward the inclined curved surface and on the surface of the curved lens toward the bottom case.

13. The signal light as claimed in claim 8, wherein the concentrator structure array takes the axis part as a center and represents an axial symmetric shape, and the axis part is located at the curved lens center.

14. The signal light as claimed in claim 8, wherein the axis part is not located at the curved lens center.

15. The signal light as claimed in claim 8, wherein the axis part is located on a surface of the curved lens toward the inclined curved surface, or located on a surface of the curved lens toward the bottom case, or both are located on the surface of the curved lens toward the inclined curved surface and on the surface of the curved lens toward the bottom case.

16. The signal light as claimed in claim 15, wherein the concentrator structure array is located on the surface of the curved lens toward the inclined curved surface, or located on the surface of the curved lens toward the bottom case, or both are located on the surface of the curved lens toward the inclined curved surface and on the surface of the curved lens toward the bottom case.
